(19) United States
(12) Patent Application Publication
(10) Pub. No.: US 2012/0040193 A1
(43) Pub. Date: Feb. 16, 2012

(54) ANTIBACTERIAL GLASS

(75) Inventor: Markku Rajala, Vantaa (FI)

(73) Assignee: BENEQ OY, Vantaa (FI)

(21) Appl. No.: 13/201,063

(22) PCT Filed: Feb. 4, 2010
(86) PCT No.: PCT/FI2010/000009

§ 371 Date: Oct. 19, 2011

(30) Foreign Application Priority Data
Feb. 17, 2009 (FI) 20090057

(51) Int. Cl. B32B 17/06

(52) U.S. Cl. 428/432

(57) ABSTRACT

A coated article is disclosed. The coated article comprises an antibacterial coating on a glass substrate, the substrate having a modified surface layer which essentially reduces the ion exchange between silver in the antibacterial coating and sodium in the glass substrate. Apparatus and method for forming such article are also disclosed.

### FIELD OF INVENTION

The invention relates to a coated article and specifically to a coated article according to the preamble of claim 1 comprising a glass substrate and a coating provided on the glass substrate, the coating comprising silver. The present invention also relates to an apparatus for providing a coated article and specifically to apparatus according to the preamble of claim 8 for forming a coated article comprising a glass substrate and a coating provided on the glass substrate. The present invention further relates to a method for producing a coated article and specifically to a method according to the preamble of claim 16 for providing a coated article comprising a glass substrate and a coating provided on the glass substrate, the coating comprising silver.

### DESCRIPTION OF THE STATE OF THE ART

An antibacterial surface increases hygiene in both industrial and domestic use. For example, antibacterial surfaces could be used in the fight against hospital bacteria. Some metals, like copper and silver ions prevent the growth of bacteria.

Silver is used on glass surfaces to generate antibacterial coatings on glass. It may be used alone in the coating or combined with titanium oxide, preferably anatase, which is a photocatalytic substance and provides, under the influence of ultraviolet light, an additional component for bacteria destruction. Silver, however, easily generates ion-exchange with sodium typically present in soda-lime glass, which is the most popular glass composition. The ion-exchange colors glass yellow, which in most cases is an undesirable feature. This is especially a problem when the coating is formed on hot glass, e.g. on-line in the float process.

Patent application publication US 2007/0245163 A1, Vijayen S. Veerasamy, et.al., Nov. 1, 2007, describes a coated article including a coating supported by a glass substrate where the coating layer comprises silver. In one embodiment of the published invention, a dielectric layer is deposited between the glass substrate and the coating comprising silver. This dielectric layer helps to separate the silver-comprising coating from the substrate. However, forming multiple coatings is tricky, especially if they are formed on hot glass. Thus there is a need for a better solution for preventing silver-sodium ion exchange.

### SUMMARY OF THE INVENTION

An object of the present invention is to provide a coated article so as to overcome the above menyioned disadvantages of the prior art. The objects of the invention are achieved by a coated article according to the characterizing portion of claim 1, by an apparatus according to the characterizing portion of claim 8 and by a method according to the characterizing portion of claim 16.

The preferred embodiments of the invention are disclosed in the dependent claims.

The main purpose of the present invention is to introduce a coated article 200 including a coating 1 supported by a glass substrate 3. The coating layer 1 comprising silver lays on the glass substrate 3. The top surface layer 2 of the glass substrate 3 is modified in such way that the ion exchange between the sodium in the glass substrate 3 and silver in the coating 1 is essentially reduced. The essential reduction may be realized by reducing sodium diffusion rate in the top surface layer 2.

The ion exchange rate may be further reduced by sodium concentration reduction on the top surface layer 2. This be carried out in several ways. In one embodiment a sulphur compound, such as sulphur dioxide is fed to the atmosphere contacting the glass surface and sulphur dioxide and sodium on the top surface layer 2 carry out an ion-exchange process resulting sodium sulphate and thus the sodium concentration in the top surface layer 2 is reduced. In another embodiment sodium migration from the top surface layer 2 is attained by simply heating the glass surface and thus increasing sodium out-diffusion rate from the top surface layer 2.

In addition to silver, the coating 1 may also include titanium, preferably in the form of anatase, providing additional mechanism for the bacteria destruction. Coating 1 may be a uniform film or it may consist of essentially individual nanoparticles. The word ‘essential’ in this case means that the nanoparticles may be individual primary particles or they may be agglomerated to larger particles consisting of more than one primary particle.

Another feature of the invention is an apparatus 100 for producing the coated article 200. In one embodiment the apparatus 100 includes means 6 for heating the glass surface by a flame 7 and thus out-diffusing sodium ions from the top surface layer 2. The out-diffusion is increased by feeding a compound comprising sulphur, fluorine or chlorine at least on the surface of the hot glass substrate.

### BRIEF DESCRIPTION OF THE DRAWINGS

In the following, the invention will be described in more detail with reference to the appended principle drawing, in which

FIG. 1 shows the coated glass structure without any modification of the top surface layer 2;

FIG. 2 shows an embodiment of the invented article 200, where the coating 1 is a uniform film and the aluminum concentration in the top surface layer 2 is essentially higher than the average aluminum concentration in the glass substrate 3;

FIG. 3 shows an embodiment of the invented article 200, where the coating 1 consists of essentially individual nanoparticles, the aluminum concentration in the top surface layer 2 is essentially higher than the average aluminum concentration in the glass substrate 3 and the sodium concentration in the top surface layer 2 is essentially lower than the average sodium concentration in the glass substrate 3;

FIG. 4 shows an embodiment of the invented apparatus 100, including means 16 for feeding sulphur oxide next to the glass surface; and

For the sake of clarity, the figures only show the details necessary for understanding the invention. The structures and details which are not necessary for understanding the invention and which are obvious for a person skilled in the art have been omitted from the figures in order to emphasize the characteristics of the invention.

### DETAILED DESCRIPTION OF PREFERRED EMBODIMENTS

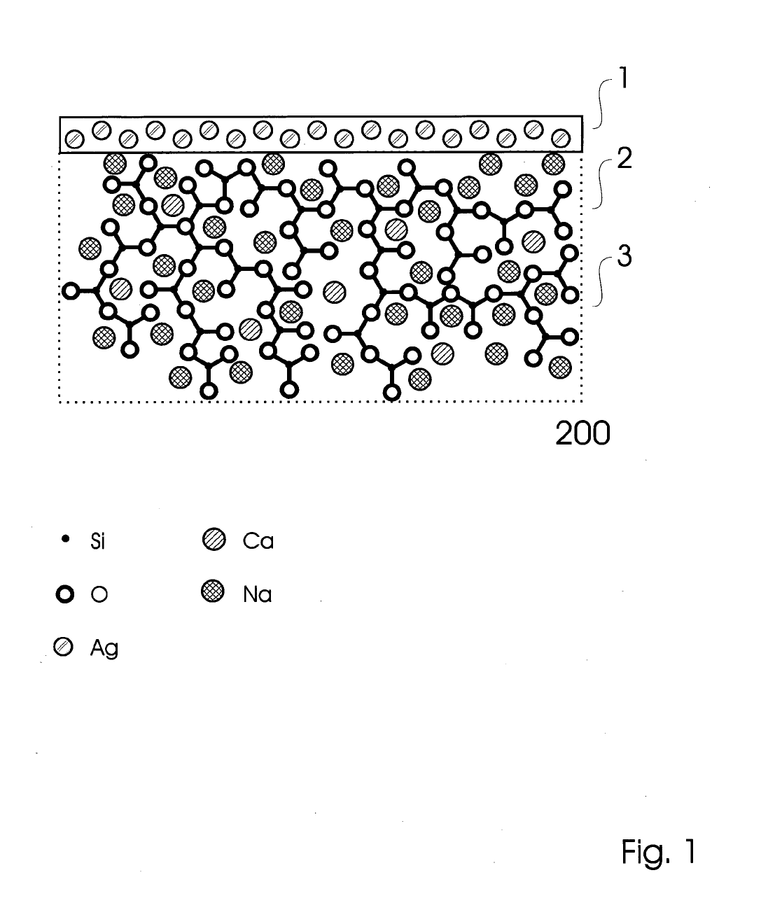

FIG. 1 shows, in principle, article 200 comprising a glass substrate 3 and a coating 1 provided on the glass substrate 3. The glass substrate 3 comprises a top surface layer 2 with sodium diffusion rate lower than the average sodium diffusion rate of the glass substrate 3 and the a coating 1 comprising silver (Ag) lays on the surface of the glass substrate 3. The glass substrate 3 consists of silica (SiO₂) network which is modified by calcium (Ca) and sodium (Na) atoms. When the modifier cations are introduced, by melting Na₂O and CaO together with SiO₂, some Si—O—Si bridges are broken. Then oxygen atoms occupy the free ends of separated tetrahedral and form non-bridging oxygen (NBO) units. The NBO units are the anionic counterparts of the Na and Ca cations. The modifier cations (Na⁺ and Ca²⁺) are mainly incorporated at the severance sites of the silica network. The structure provides a stronger linkage of the network to the divalent alkaline-earth ions than to the monovalent alkali ions. Thus, the Na ions are considerably more mobile than the Ca ions. The diffusion rate of sodium and alkali metals in general, is much higher than the diffusion rate of alkaline-earth metals, such as calcium, a common modifier in soda-lime glass. Thus it is much easier to out-diffuse sodium from the glass substrate 3 than to out-diffuse e.g. calcium. Sodium can be out-diffused by merely heating the glass substrate 3. In order to prevent excess heating of the whole substrate 3, which would cause warping of the glass substrate 3; it is advantageous to heat the surface layer 2 only. Preferably such heating is carried out by convection. In the preferred embodiment heating is carried out by a flame 7, preferably an oxy-hydrogen flame, impinging the glass substrate 3. Sodium out-diffusion may be further enhanced by adding some sulphur or fluorine or chlorine compound, such as sulphur dioxide to the atmosphere next to the glass surface. Such a de-alkalization process is a well known surface modification process as such, wherein a thin surface layer 2 is created that has a lower concentration of alkali ions than is present in the underlying. In silicate glasses, de-alkalized surfaces are also often considered “silica-rich” since the selective removal of alkali ions can be thought to leave behind a surface layer 2 composed primarily of silica (SiO₂). More precisely, de-alkalization does not generally involve the outright removal of alkali from the glass 3, but rather its replacement with protons (H⁺) or hydronium ions (H₃O⁺) in the structure through the ion-exchange process. A rapid ion-exchange process that depletes the surface layer 2 of sodium is usually performed when the glass is at high temperature, usually in the order Of 500-650° C. or greater. The sulphate treatment can be carried out by flooding the surface of the glass substrate 3 by sulphur dioxide (SO₂) or sulphur trioxide (SO₃) gases, especially in the presence of water, which enhances the ion exchange reaction. Alternatively the sulphate treatment may be carried out by aqueous solutions of ammonium sulphate salt. Treatment with fluorine-containing compounds may be accomplished by a fluorinated gas mixture flooding the surface of the glass substrate 3 at high temperatures. Treatment with chlorine-containing compounds may be accomplished by a chlorinated gas mixture flooding the surface of the glass substrate 3 at high temperatures.

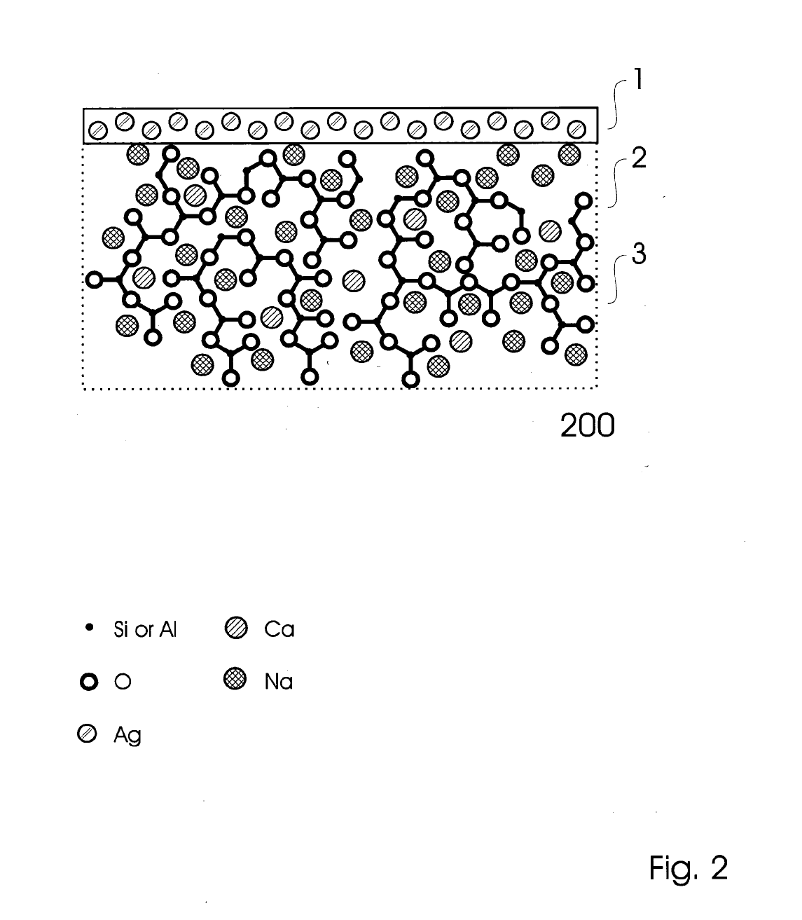

FIG. 2 shows, in principle, a first embodiment of the invented article 200, where the glass structure in the top surface layer 2 of the glass substrate 3 is modified in such way that the ion exchange rate between the silver ions in the coating 1 and the top surface layer 2 is reduced. Thus the glass composition of the top surface layer 2 of the glass substrate 3 is different from the average glass composition in the glass substrate 3 such that the sodium diffusion rate in the top surface layer 2 of the glass substrate is lower 3 than the average sodium diffusion rate in the glass substrate 3. Addition of trivalent elements, such as aluminum, can create a site in the lattice structure functioning to tie up terminal alkali and hydroxyl groups. This reduces the diffusion of sodium from the glass substrate 3 to the coating 1 and thus essentially reduces the ion exchange between the sodium and silver ions.

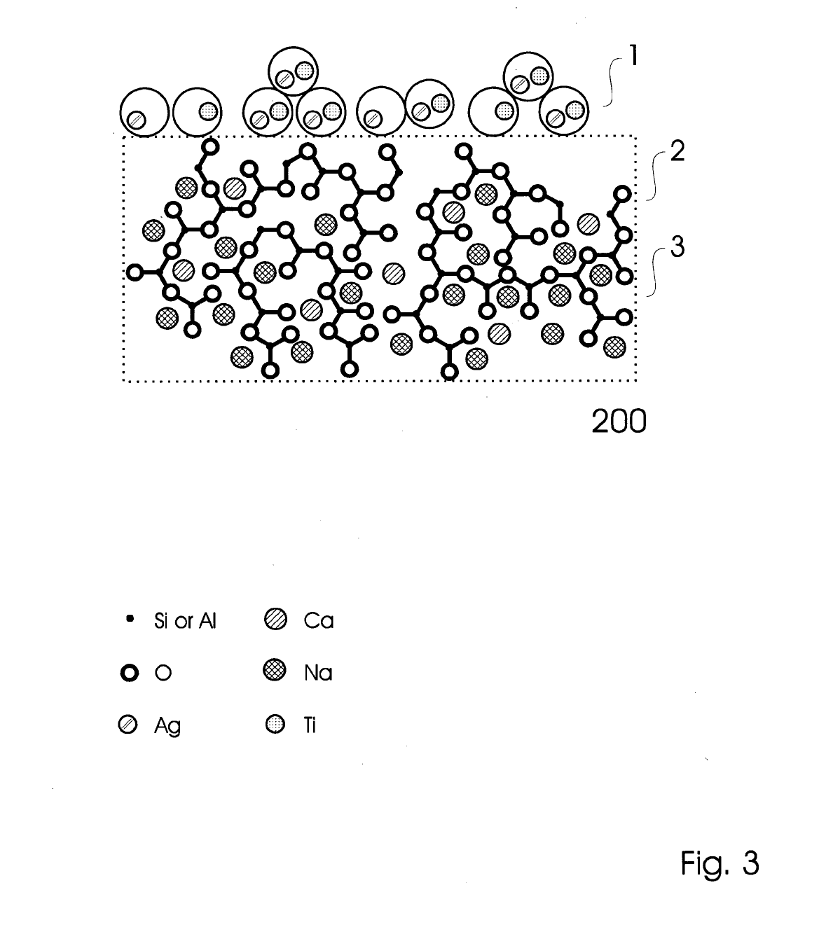

FIG. 3 shows, in principle, a second embodiment of the invented article 200, where the coating 1 consists of essentially individual nanoparticles, the aluminum concentration in the top surface layer 2 is essentially higher than the average aluminum concentration in the glass substrate 3 and the sodium concentration in the top surface layer 2 is essentially lower than the average sodium concentration in the glass substrate 3. Coating 1 comprises primary nanoparticles, typically with a diameter less than 100 nm or nanoparticles clusters or agglomerates, which consist of more than one primary nanoparticles. The nanoparticles may comprise titanium in addition to silver. The inventor has found that as the contact area between the coating and the surface of the glass substrate is reduced, there are fewer routes for the ion exchange. Thus individual particles or agglomerates are a more preferred coating than a continuous film.

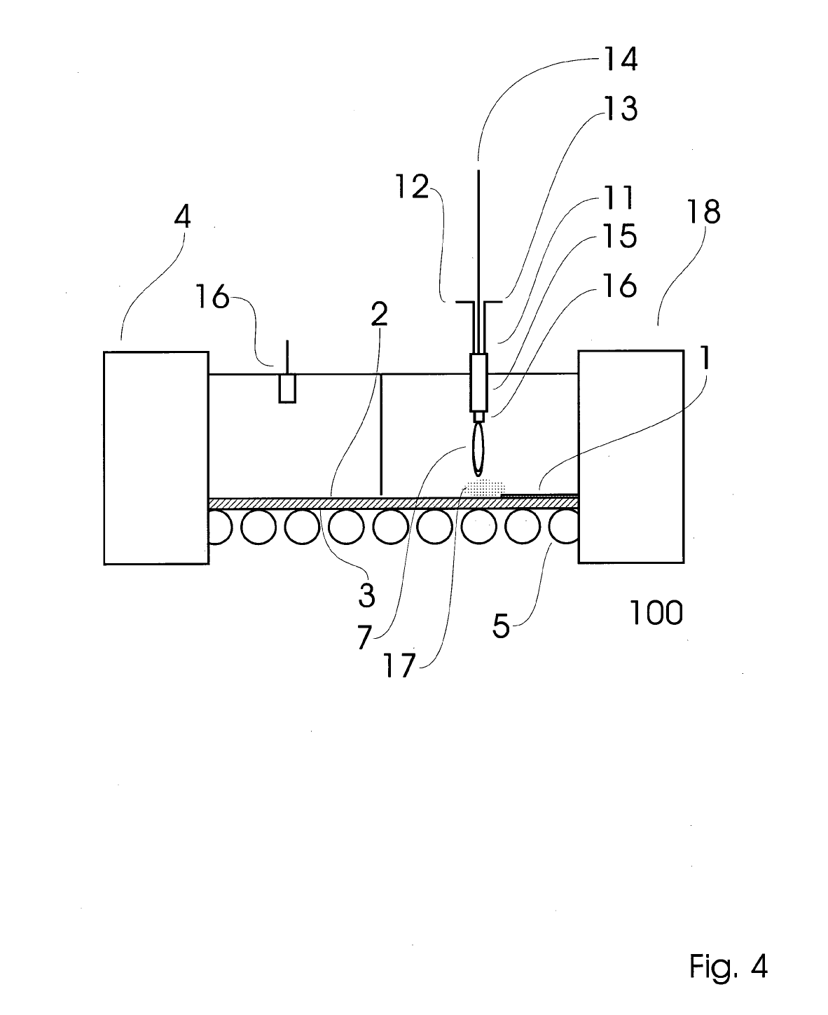

FIG. 4 shows, in principle, a first embodiment of the invented apparatus 100 for forming the invented article. Glass substrate 3 moves from left to right on the conveyor means 5. The substrate 3 may either be a continuous glass ribbon, like in the float glass process, or the substrate 3 may be one or a series of glass plates. The substrate 3 arrives hot from heating means 4 such as a chamber 4, which may be e.g. the tin bath of the float process or a separate heating furnace. The top surface of the substrate 3 treated by substrate surface treating means 16 with a de-alkalizing gas, typically a sulphur-, fluorine-, or chlorine compound fed through the connector 16. The de-alkalizing gas causes an ion-exchange reaction and the sodium concentration in the top layer 2 of the glass substrate 3 is essentially reduced. The coating means 11 then provides a coating on the substrate 3 having a de-alkalized top layer 2. Liquid precursor 14 comprising silver is fed into the liquid-flame-spraying-type coating device 11. The precursor is atomized in the two-fluid atomizer nozzle 16 by either the fuel gas 12 or the oxidizing gas 13. A flame 7 is generated in the burner unit 15 integrated to the coating means 11. The atomized precursor 14 evaporates in the flame 7 and nanosized silver particles 17 are formed. These particles deposit on the substrate 3 forming either a continuous coating film or a coating consisting of essentially separate nanoparticles or nanoparticles clusters 1. The coated article may be further heat treated by post heating means, e.g. annealed in a furnace 18. Thus substrate surface treating means 16 are arranged to feed a compound comprising sulphur or fluorine or chlorine at least on the top surface 2 of the glass substrate 3 and the coating means 11 are arranged to spray a liquid precursor 13 comprising silver on the top surface 2 of the glass substrate 3 for providing the coating 1. The coating means 11 are further arranged to generate a flame 7 for spraying the liquid precursor 13 through the flame 7. The coating means 11 may be arranged to generate the coating 1 from essentially individual nanoparticles.

The apparatus 100 of FIG. 1 may be to carry out a method for producing a coated article 200 comprising a glass substrate 3 and a coating 1 provided on the glass substrate 3, the coating 1 comprising silver. The method comprises treating the glass substrate 3 for providing the glass substrate 3 with a top surface layer 2 having reduced sodium concentration and providing the top surface layer 2 of the glass substrate 3 with a coating 1 comprising silver such that an article according to the present invention and above mentioned is obtained.

It is possible to produce various embodiments of the invention in accordance with the spirit of the invention. Therefore, the above-presented examples must not be interpreted as restrictive to the invention, but the embodiments of the invention can be freely varied within the scope of the inventive features presented in the claims herein below.

1-3. (canceled)

4. A coated article comprising a glass substrate and a coating provided on the glass substrate, the coating comprising silver, wherein aluminum concentration in a top surface layer of the glass substrate is higher than the average aluminum concentration in the glass substrate and the coating is generated from essentially individual nanoparticles.

5. The coated article of claim 4, wherein sodium concentration in said top surface layer of the glass substrate is lower than the average sodium concentration in the glass substrate.

6. The coated article of claim 4, wherein the coating further comprises titanium.

7-16. (canceled)

17. The coated article of claim 5, wherein the coating further comprises titanium.
